(19) United States
(12) Patent Application Publication
(10) Pub. No.: US 2023/0415238 A1
(43) Pub. Date: Dec. 28, 2023

(54) BUILD SUBSTRATE FOR DIRECTED ENERGY DEPOSITION ADDITIVE MANUFACTURING

(71) Applicant: Essentium IPCO, LLC, Pflugerville, TX (US)

(72) Inventor: Charles Brandon Sweeney, Pflugerville, TX (US)

(21) Appl. No.: 18/359,455

(22) Filed: Jul. 26, 2023

Related U.S. Application Data
(63) Continuation of application No. PCT/US22/13854, filed on Jan. 26, 2022.
(60) Provisional application No. 63/148,360, filed on Feb. 11, 2021.
(60) Provisional application No. 63/143,661, filed on Jan. 29, 2021.

(51) Int. Cl. B22F 12/30; B22F 10/43

(52) U.S. Cl. CPC B22F 12/30; B33Y 10/00; B22F 10/43

(57) ABSTRACT

A build substrate for supporting an article during a directed energy deposition (DED) process includes a clad metal layer defining a build surface, where the article is fused to the build surface during deposition. The build substrate also includes a support substrate configured to support stresses and temperatures experienced during deposition. The support substrate defines an upper surface and a lower surface, and at least a portion of the upper surface of the support substrate is covered with the clad metal layer.

### CROSS-REFERENCE TO RELATED APPLICATIONS

This application claims priority to U.S. Application No. 63/143,661 filed on Jan. 29, 2021, and claims priority to U.S. Application No. 63/148,360 filed Feb. 11, 2021 the teachings of which are incorporated herein by reference.

### FIELD

The present disclosure is directed to a build substrate for directed energy deposition (DED) additive manufacturing.

### BACKGROUND

The statements in this section merely provide background information related to the present disclosure and may or may not constitute prior art.

Directed energy deposition (DED) refers to a category of additive manufacturing or three-dimensional printing techniques that involve a feed of powder or wire that is melted by a focused energy source to form a melted or sintered layer on a substrate. Although the focused energy source is usually a laser beam, a plasma arc or an electron beam may be used instead. The DED process is predominantly used with metals such as titanium, stainless steel, aluminum, and their alloys.

Existing DED technologies build components upon metallic substrates that are relatively thick and bulky in order to support the stresses that accumulate as the component is printed using a layering process. After the deposition process is complete, the finished component is permanently bonded to a build surface of the metallic substrate. As a result, a bandsaw, wire electro discharge machining (EDM), or other cutting technique is usually required to separate the finished component from the build surface of the metallic substrate. These cutting techniques result in additional post processing equipment, which may be expensive, energy intensive, and also occupies valuable space on the production floor.

Thus, while build surfaces used in additive manufacturing techniques achieve their intended purpose, there is a need for new and improved build surfaces used in DED processes.

### SUMMARY

According to several aspects, a build substrate for directed energy deposition (DED) additive manufacturing is disclosed. In one embodiment, the build substrate includes a clad metal layer defining a build surface, where an article is fused to the build surface during deposition. The build substrate also includes a support substrate configured to support stresses and temperatures experienced during deposition. The support substrate defines an upper surface and a lower surface, and at least a portion of the upper surface of the support substrate is covered with the clad metal layer.

In another aspect, a method of creating an article by a DED process is disclosed. The method includes depositing a build material by a nozzle upon a build substrate, where the build substrate supports the article during the DED process. The method also includes fusing the article to a build surface, where the build surface is defined by a clad metal layer, and where the build substrate further includes a support substrate configured to support stresses and temperatures experienced during deposition. The support substrate defines an upper surface and a lower surface and at least a portion of the upper surface of the support substrate is covered with the clad metal layer.

Further areas of applicability will become apparent from the description provided herein. It should be understood that the description and specific examples are intended for purposes of illustration only and are not intended to limit the scope of the present disclosure.

### BRIEF DESCRIPTION OF DRAWINGS

The drawings described herein are for illustration purposes only and are not intended to limit the scope of the present disclosure in any way.

FIG. 1 is a schematic diagram of a three-dimensional printer used in a DED process, where the three-dimensional printer employs the disclosed build substrate;

FIG. 2 is a schematic diagram illustrating one embodiment of the disclosed build substrate including a clad metal layer that is dissolved;

FIG. 3A is a schematic diagram illustrating another embodiment of the disclosed build substrate where the clad metal layer is patterned;

FIG. 3B illustrates one example of the pattern that may be used for the build substrate shown in FIG. 3A; and

FIG. 4 is a schematic diagram illustrating yet another embodiment of the disclosed build substrate.

### DETAILED DESCRIPTION

The following description is merely exemplary in nature and is not intended to limit the present disclosure, application, or uses.

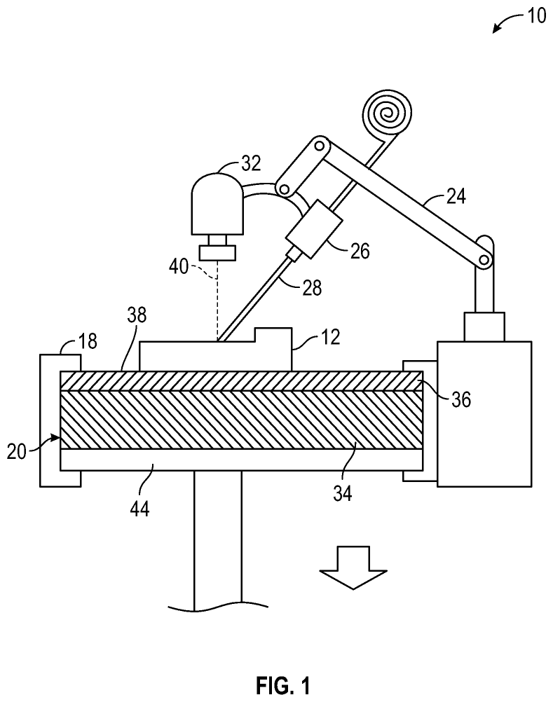

The present disclosure is directed to a build substrate used in a directed energy deposition (DED) process. Referring now to FIG. 1, a three-dimensional printer 10 for creating an article 12 based on the DED process is illustrated. In the non-limiting embodiment as shown in FIG. 1, the three-dimensional printer 10 includes a build substrate 20 for providing support to the article 12, a fixture 18 for securing the support substrate 20, an arm 24, a nozzle 26 configured to deposit a build material 28, and an energy source 32. The build substrate 20 includes a support substrate 34 and a clad metal layer 36, where the clad metal layer 36 defines a build surface 38 that the article 12 is placed upon during the deposition process. The build substrate 20 becomes part of the finished article 12. That is, the article 12 is fused to the clad metal layer 36 of the build substrate 20 during deposition. It is to be appreciated that the build substrate 20 may not be reused for subsequent builds and is considered consumable. As explained below, the build surface 38 of the build substrate 20 promotes facile removal of the article 12 once the deposition process is complete. That is, the article 12 may be removed from the build substrate 20 without the assistance of a bandsaw, wire electro discharge machining (EDM), or other equipment-intensive techniques.

The build material 28 is used to create the article 12 and may be any type of metal employed in a DED process such as, for example, titanium, stainless steel, aluminum, copper, nickel, Inconel, cobalt alloys, Zircalloy, tantalum, tungsten, niobium, molybdenum, and their alloys. In the embodiment as shown in FIG. 1, the build material 28 is in wire form, and the nozzle 26 is mounted to the arm 22, which may be a multi-axis arm having four, five, or six axes. Although FIG. 1 illustrates the build material 28 in wire form, the build material 28 is not limited to a wire, and in another embodiment the build material 28 may be in powder form. The build material 28 is fed to the nozzle 26 and is deposited onto either the build surface 38 or the article 12. As the build material 28 is deposited, a focused energy beam 40 generated by the energy source 32 melts the build material 28 onto either the build surface 38 or the article 14. In one embodiment, the focused energy beam 40 is a laser beam, however, in another implementation the focused energy beam 40 may be a plasma arc or an electron beam.

The build substrate 20 is secured to an actuated z-axis build tray 44 using the fixture 18. The fixture 18 may be any device configured to securely attach the build substrate 20 to the z-axis build tray 44 such as, but not limited to, clamps, vacuum, or magnets. The article 12 is seated upon and is fused to the build surface 38 of the clad metal layer 36 of the support substrate 20 during deposition, and the support substrate 34 is configured to support stresses and temperatures experienced during deposition. M-It is to be appreciated that most metals have a well-defined positive coefficient of thermal expansion, which implies that a metal that is deposited during the DED process will shrink from its initial as-deposited dimensions and temperatures to a final dimension and a final temperature as the article 12 reaches equilibrium with a build chamber environment. By calculating a temperature differential, and overall part dimensions, an approximate contraction strain and in turn stress may be determined for any metal DED part geometry. It follows that the build substrate 20 is selected to have an appropriate flexural modulus and strength to withstand the aforementioned calculated stresses caused by the cooling and contraction of the article 12.

The temperatures experienced by the support substrate 34 depend upon the build material 28 that is used during the deposition process. Specifically, in the event the build material 28 includes a melt temperature, then the support substrate 20 includes a melt temperature that is higher than the melt temperature of the build material 28. However, if the build material 28 is a non-melting material such as an epoxy, then the support substrate 20 includes a melt temperature that is higher than a degradation temperature of the build material 28. The degradation temperature of the build material 28 is determined based on thermogravimetric analysis (TGA).

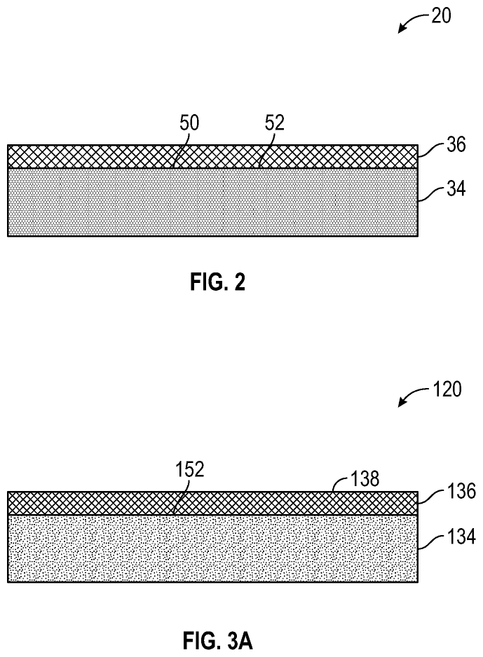

FIG. 2 illustrates one embodiment of the build substrate 20, where the build substrate 20 defines an upper surface 52 and a lower surface 54, where at least a portion of the upper surface 52 of the build substrate 20 is covered with the clad metal layer 36. In the embodiment as shown in FIG. 2, the clad metal layer 36 covers the entire upper surface 52 of the build substrate 20, where the clad metal layer 36 is constructed of a metal that is soluble in a substance that the build material 28 is insoluble within. Accordingly, when the article 12 (seen in FIG. 1) and the build substrate 20 are placed within a solvent bath, the clad metal layer 36 is dissolved, and the article 12 remains intact. In one exemplary embodiment, the article 12 is constructed of stainless steel, the clad metal layer 36 is constructed of copper, and the support substrate 34 is constructed of glass-reinforced epoxy laminate material (FR4). Accordingly, when the article 12 and the build substrate 20 are placed in a solvent bath of sodium hydroxide or ferric chloride respectively, the clad metal layer 36 is removed, however, the article 12 and the support substrate 34 remain intact. Since the clad metal layer 36 was removed in the solvent bath, the article 12 has been separated from the build substrate 20.

In one embodiment, the support substrate 32 is constructed of a perforated or porous material that is configured to promote the diffusion of the solvent to a back face 50 of the clad metal layer 36, which in turn accelerates the etching of the clad metal layer 36 in a solvent bath. The specific density and porosity of the material used for the support substrate 32 may be tuned or adjusted based on the application. One example of a porous material that may be used for the support substrate 32 is fritted glass, which is finely porous glass through which gas or liquid may pass.

Referring to both FIGS. 1 and 2, in one embodiment the three-dimensional printer 10 may employ a sacrificial or ablative material that is used to support various features of the article 12. It is to be appreciated that the ablative material is removed from the article 12 once the deposition process is complete. The build surface 38 of the support substrate 20 is configured to adhere to the ablative material during the deposition process. In one implementation, the ablative material is pretreated by the focused energy beam 40 and is then fused to the build surface 38 of the build substrate.

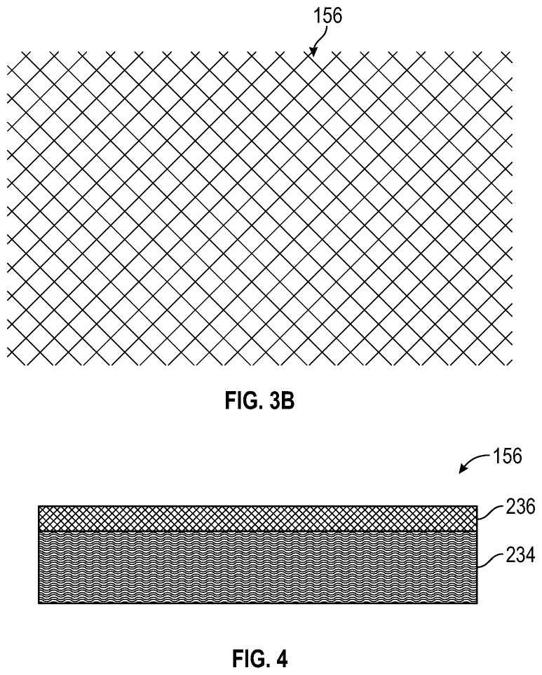

FIGS. 3A and 3B illustrate another embodiment of the build substrate 120 where only a portion of an upper surface 152 of the support substrate 134 is covered with the clad metal layer 136. Specifically, referring to FIG. 3B, the clad metal layer 136 is applied as a pattern 156 upon the upper surface 152 of the support substrate 132. That is, only a portion of the upper surface 152 of the support substrate 134 is coated with the clad metal layer 136. As a result, a partial or weakened bond is created between the build surface 138 of the support substrate 20 and the article 12 (seen in FIG. 1). In one embodiment, the pattern 156 may be created by the focused energy beam 40 depositing the clad metal layer 136 upon the support substrate 132 prior to a deposition process for fabricating the article 12. Alternatively, in another embodiment, the pattern 156 is created before the support substrate 20 is secured to the three-dimensional printer 10 (FIG. 1). In one exemplary embodiment, the clad metal layer 136 may be constructed of a metal such as copper and the support substrate 132 is constructed of a ceramic material such as aluminum oxide.

In the non-limiting embodiment as shown in FIG. 3B, the pattern 156 is a cross-hatched pattern, however, it is to be appreciated that this illustration is merely exemplary in nature and any number of patterns may be used as well such as, for example, a dot-matrix pattern. In one embodiment, the pattern 156 is tuned or selected so as to result in a specific amount of coverage across the upper surface 152 of the support substrate 132. For example, a specific pattern may result in about 25-75 percent of the upper surface 152 of the support substrate 132 being covered by the clad metal layer 136. Regardless of the specific pattern employed, the resolution of the pattern 156 is one-half or less than a bead size of the build material 28 being deposited by the three-dimensional printer 10 (seen in FIG. 1). The partial bond that is created between the build surface 138 of the support substrate 120 and the article 12 (seen in FIG. 1) as a result of the pattern 156 disposed along the build surface 138 of the support substrate 120 promotes facile removal of the article 12 from the build substrate 120. More specifically, the partial bond between the build substrate 120 and the article 12 may allow for a user to remove the article 12 by mechanically flexing the support substrate 20. In another example, the article 12 may be removed from the build substrate 20 using a micro jackhammer or other tool that imparts relatively low forces. Regardless of the technique used to remove the article 12 from the support substrate 20, it is to be appreciated that the partial bond allows for the article 12 to be removed without the need to use equipment such as bandsaw or EDM.

FIG. 4 is yet another embodiment of the build substrate 220 where the support substrate 234 is constructed of a material that is soluble in a solution such as water. Accordingly, when the support substrate 220 is placed in a solution such as water, the support substrate 234 dissolves, thereby leaving behind the clad metal layer 236 and the article 12 (seen in FIG. 1). It is to be appreciated that the thickness of the clad metal layer 236 is well under one millimeter and is extremely thin, and in one embodiment ranges from about 0.089 millimeters to about 0.355 millimeters. As a result, a user may easily break away or otherwise remove the clad metal layer 236 from the article 14 manually, without the need for any tools. In one embodiment, the clad metal layer 236 is constructed from the same material as the article 12. One example of a material that may be used for the support substrate 234 is a water-soluble ceramic binder including either glass powder or fiber as the matrix material and potassium carbonate (K₂CO₃) as the binder. In another example, a water-soluble mandrel material may be used to construct the support substrate 234.

Referring generally to the figures, the disclosed build substrate provides various technical effects and benefits. Specifically, the build substrate provides support to an article during the DED process, where the article is subjected to elevated temperatures and stresses. However, once the deposition process is complete, the article may be easily removed from the clad metal layer, without the need to use a bandsaw, EDM, or other cutting technique involving large and bulky machinery.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. A build substrate for supporting an article during a directed energy deposition (DED) process, the build substrate comprising:
a clad metal layer defining the build surface, wherein the article is fused to the build surface during deposition; and
a support substrate configured to support stresses and temperatures experienced during deposition, wherein the support substrate defines an upper surface and a lower surface and at least a portion of the upper surface of the support substrate is covered with the clad metal layer.

2. The build substrate of claim 1, wherein the build substrate is constructed of a material having a melt temperature that is higher than a melt temperature of a build material, and wherein the article is constructed of the build material.

3. The build substrate of claim 1, wherein the build substrate is constructed of a material having a melt temperature that is higher than a degradation temperature of a build material, and wherein the article is constructed of the build material.

4. The build substrate of claim 1, wherein the clad metal layer is constructed of a metal that is soluble in a substance that the build material is insoluble within.

5. The build substrate of claim 4, wherein the article is constructed of a build material, and wherein the build material includes one or more of the following: titanium, stainless steel, aluminum, copper, nickel, Inconel, cobalt alloys, Zircalloy, tantalum, tungsten, niobium, molybdenum, and their alloys.

6. The build substrate of claim 5, wherein the build material is stainless steel, the clad metal layer is constructed of copper, and the support substrate is constructed of a glass-reinforced epoxy laminate material (FR4).

7. The build substrate of claim 1, wherein the support substrate is constructed of a porous material configured to promote the diffusion of a solvent to a back face of the clad metal layer.

8. The build substrate of claim 7, wherein the porous material is fritted glass.

9. The build substrate of claim 1, wherein only a portion of the upper surface of the support substrate is covered with the clad metal layer.

10. The build substrate of claim 9, wherein the clad metal layer is applied as a pattern upon the upper surface of the support substrate.

11. The build substrate of claim 10, wherein the pattern is a cross-hatched pattern or a dot-matrix pattern.

12. The build substrate of claim 10, wherein a partial bond exists between the build surface of the support substrate and the article.

13. The build substrate of claim 10, wherein the pattern results in between 25 to 75 percent of the upper surface of the support substrate being covered by the clad metal layer.

14. The build substrate of claim 10, wherein the clad metal layer is constructed of copper and the support substrate is constructed of a ceramic material.

15. The build substrate of claim 1, wherein the support substrate is soluble in water.

16. The build substrate of claim 15, wherein the support substrate is a water-soluble ceramic binder including either glass powder or fiber as a matrix material and potassium carbonate as a binder.

17. The build substrate of claim 15, wherein the thickness of the clad metal layer ranges from about 0.089 millimeters to about millimeters.

18. A method of creating an article by a DED process, the method comprising:
depositing a build material by a nozzle upon a build substrate, wherein the build substrate supports the article during the DED process; and
fusing the article to a build surface, wherein the build surface is defined by a clad metal layer, and wherein the build substrate further includes a support substrate configured to support stresses and temperatures experienced during deposition, wherein the support substrate defines an upper surface and a lower surface and at least a portion of the upper surface of the support substrate is covered with the clad metal layer.

19. The method of claim 18, wherein the method further comprises:
once the DED process is complete, removing the article from the build substrate.

20. The method of claim 18, wherein the method further comprises:
once the DED process is complete, placing the build substrate in a solvent bath to dissolve the clad metal layer, wherein the article remains intact in the solvent bath.
